(19) United States
(12) Patent Application Publication
(10) Pub. No.: US 2013/0008746 A1
(43) Pub. Date: Jan. 10, 2013

(54) SYSTEM AND METHOD FOR ENCLOSED AND AUTOMATED LUBRICATION OF FASTENERS

(76) Inventors: VASKRSIJE JANKOVIC, KENOSHA, WI (US); MILAN STEFANOVIC, PLEASANT PRAIRIE, WI (US)

(21) Appl. No.: 13/543,785

(22) Filed: Jul. 6, 2012

Related U.S. Application Data
(60) Provisional application No. 61/504,711, filed on Jul. 6, 2011.

(51) Int. Cl. F16N 5/00

(52) U.S. Cl. 184/26; 184/14

(57) ABSTRACT

An apparatus, system, and method for the enclosed and automated lubricating of fasteners is disclosed. In one embodiment, the apparatus includes a sleeve having an inside diameter larger than a diameter of the fastener, wherein the sleeve has at least one conduit located therein for dispensing lubricant onto the fastener; and a lubricant supply line coupled to the sleeve for supplying lubricant into the inside diameter of the sleeve for lubricating the fastener. The sleeve also has a pilot for maintaining the sleeve in a centered location about the fastener, wherein the centering ring has a diameter larger than the diameter of the fastener and smaller than the inside diameter of the sleeve. An optional scraper, such as an o-ring, is coupled to the sleeve to remove excess lubricant from the fastener when the fastener is removed from the sleeve.

### CROSS-REFERENCE TO RELATED APPLICATIONS

This application claims priority to provisional application, U.S. Ser. No. 61/504,711 filed Jul. 6, 2011, entitled SYSTEM AND METHOD FOR AUTOMATICALLY LUBRICATING FASTENERS, which application is also incorporated herein by its reference, in its entirety.

### FIELD OF TECHNOLOGY

This disclosure relates generally to the technical field of fasteners, and in one example embodiment, this disclosure relates to a method, apparatus and system of lubricating fasteners.

### BACKGROUND

Fasteners such as bolts and screws are ubiquitous in every area of industry and life. Despite the decades of use, fasteners still have nagging problems. Installing a fastener quickly and easily is often complicated by rust, corrosion, and contaminant in the threads. Fasteners may bind, squeak, and chatter when running them down onto a mating part, long before bottoming out and imparting a tensile load on the fastener.

Additionally, obtaining a desired clamping force from the fastener on the parts it fastens together can be hampered by high dynamic friction and static friction (stiction), and variation thereof. It is difficult to measure a resultant tension on a fastener conveniently when torquing the fastener. Thus, pragmatic tools such as a torque wrench are used to measure torque as an indirect indication of the desired theoretical load, or tension, on the fastener. However, when a fastener has a higher than normal static and/or dynamic coefficient of friction, more of the torque is consumed to overcoming the friction on the threads and less of the torque is applied to the axial loading on the fastener, which can result in a lower than desired clamping load. Conversely, when a fastener has a lower than normal, e.g., lower than design, friction on the threads, then less of the torque is used to overcome the friction and more of the torque is used on the axial loading on the threads, which can result in a higher than expected loading that may even exceed a strength of some of the parts in the assembly. It is this variation in friction that can cause inconsistency in clamping load between different fasteners.

Finally, the task of easily removing fasteners can again be hampered by rust, corrosion, and contamination on the threads. Exposure to moisture, hostile environments, galvanic action, and other factors can cause parts, such as a bolt and nut or a bolt in a housing, to stick together, or seize. The process of breaking the parts free can be time-consuming, frustrating, and potentially damaging to the parts. Automotive and other applications subject to environmental factors such as precipitation, temperature extremes, dirt and corrosive materials such as salt, can have a higher incidence of seized fasteners and associated repair costs than fasteners used in a more controlled environment. These and other problems and limitations in the prior art exist when dealing with fasteners.

### SUMMARY

An apparatus, system, and method for automatically lubricating fasteners are disclosed. The present disclosure provides a method and system for lubricating fasteners that is quick, automated, and consistent. In particular, the fastener is lubricated entirely within a controlled enclosure. The fastener can be located in situ, e.g., as installed on a parent assembly, such as a lug on a wheel rotor on a car, or as a separate piece part, e.g., a separate fastener lubed at a workbench. The scenario for applying the lubricant can be an assembly line, a preventative maintenance (PM) operation, or a repair setting in the field. By using a controlled enclosure, the lubricant can be more uniformly applied to the fastener, the quantity of lubricant used can be reduced and more automated, and the potentially toxic or staining lubricant can be contained and managed better.

In one embodiment, the controlled enclosure apparatus for automatically lubricating fastener threads includes a sleeve with an open end to a blind hole or chamber to receive a fastener. The opposite end of the sleeve can be closed or can have a shallower blind hole for housing a receptacle to receive lubricant. The open end of the sleeve has an inside diameter larger than a diameter of the fastener to be lubricated, wherein the sleeve has at least one conduit located therein for dispensing lubricant into the chamber and onto the fastener; a coupling attached to the sleeve for receiving lubricant from an external source and communicating it via a conduit and nozzle openings to the inside diameter of the sleeve for lubricating the fastener. The sleeve also has a pilot, or centering ring, for maintaining the sleeve in a centered position about the fastener, wherein the centering diameter is larger than the diameter of the fastener and smaller than the inside diameter of the sleeve and concentric with the inside diameter of the sleeve. An optional scraper, such as an o-ring, is coupled to the sleeve to remove excess lubricant from the fastener when the fastener is removed from the sleeve. In another embodiment, the device has a plurality of conduits that are coupled to the lubricant coupling and that are located at different heights and/or different angular locations inside the sleeve for dispensing lubricant via nozzle openings into the chamber and onto the fastener. An optional adapter, having a centering diameter, or pilot, instead of the sleeve having the pilot, is rotatably disposed around the sleeve wherein the adapter more conveniently allows the sleeve to be rotated in order to lubricate the circumference of the fastener more consistently and thoroughly.

The lubricant system can be a single sleeve enclosure for manually applying lubricant to a single fastener at a time, or it can be a multi-sleeve system that can accept a plurality of fasteners, and lubricate them all in parallel using an automated and distributed lubricating conduit and a common drive mechanism that creates rotational movement between the sleeve and the fastener. With the latter embodiment, any quality of fasteners can be uniformly and thoroughly lubricated at one time, with a quick spin of a driver.

The application of the lubricant can be automated and better managed using the controlled environment, and a controlled method for applying the lubricant. For example, a controlled method of applying the lubricant can include standardized operations such as: inserting fastener into controlled enclosure; loading a specified quantity, or metered amount, of lubricant into sleeve, e.g., pumping grease gun once or a one second burst from a lubricating aerosol can; creating rotational movement between the fastener and the sleeve to distribute the lubricant to the axial and circumferential extent of the threads, e.g., rotating at least 360 degrees (one full revolution) for a single conduit row of nozzle openings; removing fastener from sleeve; and allowing scraper to remove excess lubricant during removal operation.

By applying lubricant uniformly to the threads, a fastener has a more consistent friction value during installation, with less binding, squeaking, and chattering. Consequently, the tension on the fastener, and complementary clamping force on the parts will be more precise, e.g., more consistent, and more accurate, e.g., closer to the target value. Thus, a torque wrench will more accurately provide a torque reading corresponding to a clamping load. Furthermore, with lubricated threads, the fastener is easier to remove in the future, because the lubricant staves off rust, corrosion, and galvanic action with a commensurate saving of time, effort, and part-integrity. Using the present system and method consistently on all fasteners will avoid inconsistent loading, such as under loading or over loading, which might lead to a failure in extreme cases. Thus the present disclosure will optimize productivity and quality in the delivery of services, e.g., repair or assembly of items having fasteners, over the present methods and tools, e.g., manually ‘painting’ lubricant onto a fastener usually in an inconsistent manner. Reduction in person-hours required to lubricate fasteners, including cleanup, can easily be five to tenfold. Because fasteners such as bolts and screws are ubiquitous in every area of industry and life, the present disclosure has wide and varied applications. These and other problems and limitations in the prior art are solved by the present disclosure.

The methods, systems, and apparatuses disclosed herein may be implemented in any means for achieving various aspects of the present disclosure. Other features will be apparent from the accompanying drawings and from the detailed description that follows.

### BRIEF DESCRIPTION OF THE VIEW OF DRAWINGS

Example embodiments are illustrated by way of example and not limitation in the figures of the accompanying drawings, in which like references indicate similar elements and in which:

FIG. 1 is a functional block diagram of a system that automatically lubricates fasteners, according to one or more embodiments.

FIG. 2A is an isometric view of a lubricating device, according to one or more embodiments.

FIGS. 2B and 2C are a top and cross-section view, respectively, of a lubricating device, according to one or more embodiments.

FIGS. 2D and 2E are a top and cross-section view, respectively, of a single lubricating device with an adapter, according to one or more embodiments.

FIGS. 2F and 2G are a top and cross-section view, respectively, of a gear-driven lubricating device, according to one or more embodiments.

FIGS. 2H, 2J, and 2K are magnified cross-section views of different retention systems that hold a fastener in a lubricating device, according to one or more embodiments.

FIG. 2L is a magnified cross-section view of a lubricating system 200-L having modular a sleeve insert and height spacer, according to one or more embodiments.

FIG. 3A is an isometric view of a lubricating system with multiple individual lubricating devices coupled to a single driver, according to one or more embodiments.

FIG. 4 is a flowchart of a method for lubricating a fastener, according to one or more embodiments.

Other features of the present embodiments will be apparent from the accompanying drawings and from the detailed description that follows.

### DETAILED DESCRIPTION

A method, apparatus and system for the automated lubrication of fasteners is disclosed. In the following description, for the purposes of explanation, numerous specific details are set forth in order to provide a thorough understanding of the various embodiments. It will be evident, however to one skilled in the art that various embodiments may be practiced without these specific details.

### Function Block Diagram

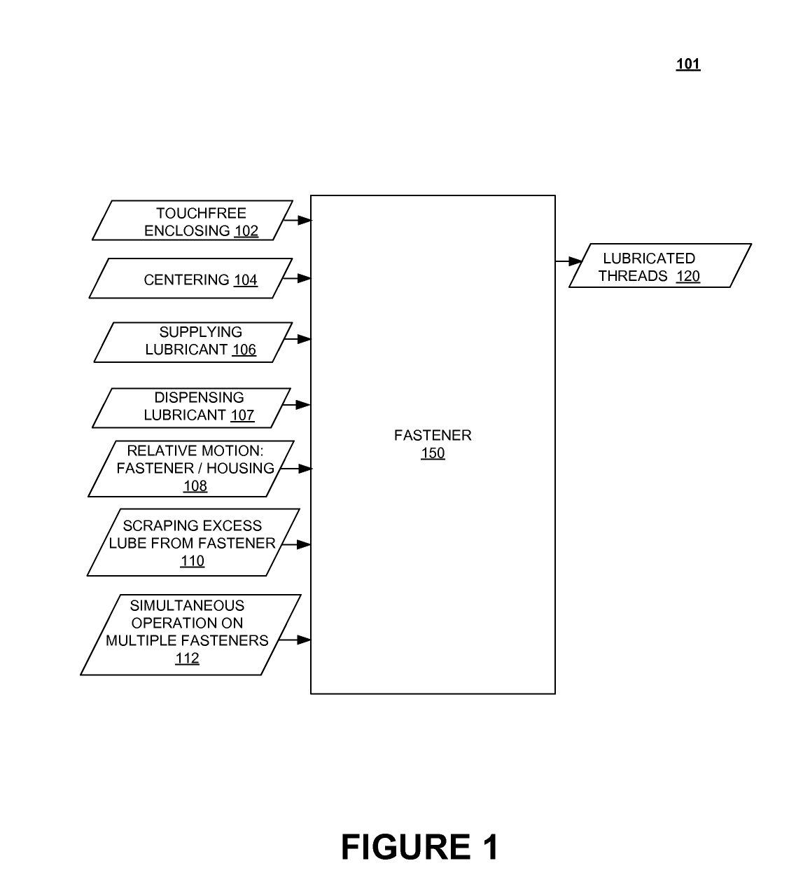

Referring now to FIG. 1, a functional block diagram 100 of a system that automatically lubricates fasteners is shown, according to one or more embodiments. The following functions operate on fastener 150: touch free (of threads) enclosing 102, centering 104, supplying lubricant 106, dispensing lubricant 107, relative motion between fastener and housing 108, scraping excess lubricant 110, and simultaneous operation on multiple fasteners. The result of these functions is to provide lubricated threads on the fastener in a manner that: quickly and automatically applies the lubricant using a standard procedure; thoroughly and uniformly applies the lubricant axially and circumferentially to threads without dry spots; neatly applies the lubricant without excessive or inconsistent portions of lubricant that might otherwise drop, smear, or stain clothing or the surroundings; and efficiently apply the lubricant without waste or excess. The functions described herein are implemented in the subsequent apparatus, systems, and methods described herein and by any means for achieving the same function, way, and results of the present disclosure.

### Lubricating Sleeve

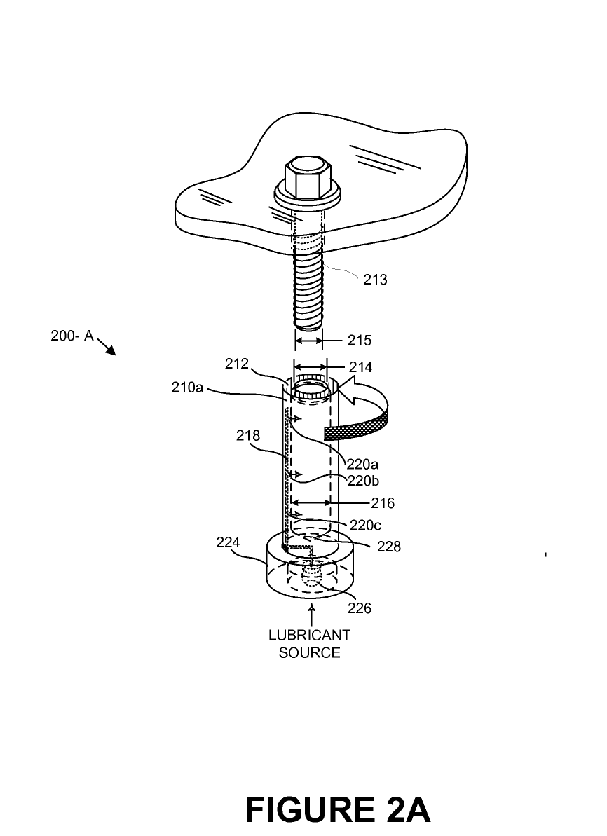

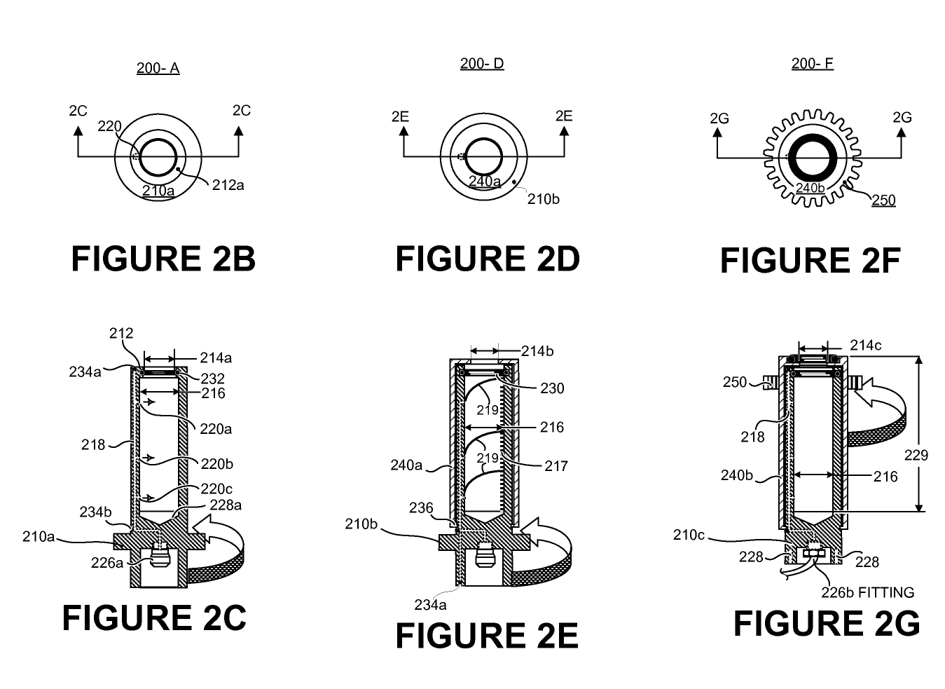

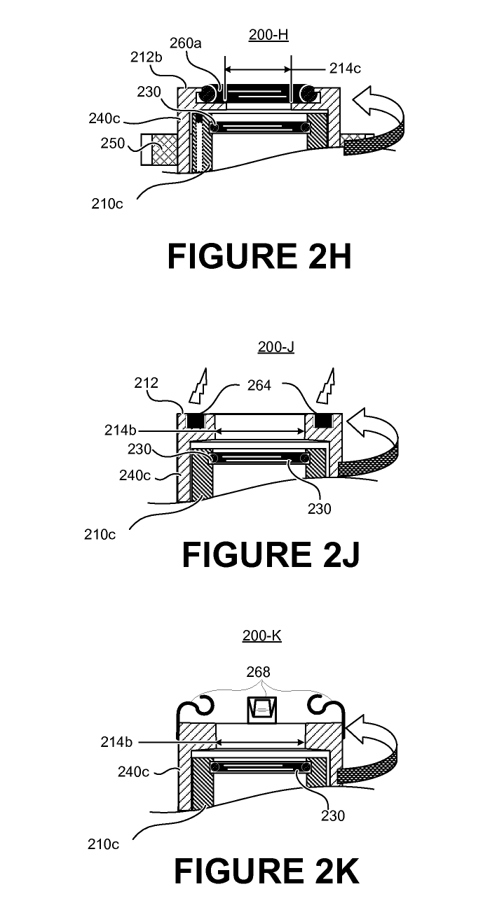

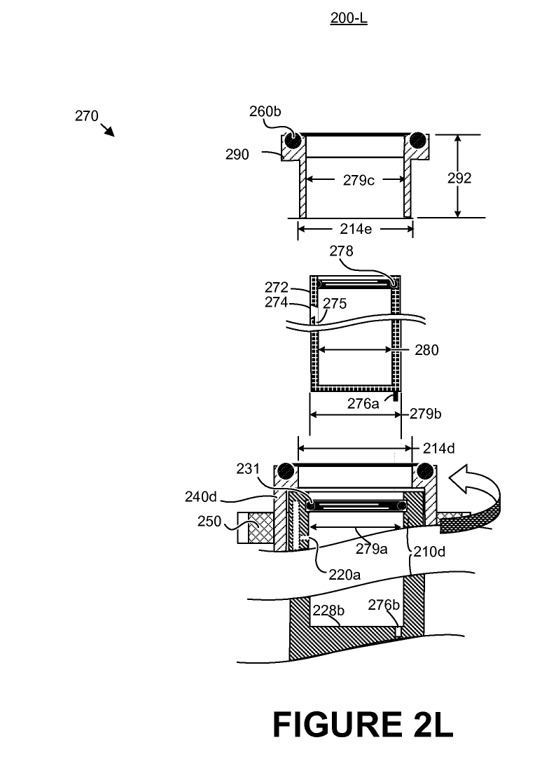

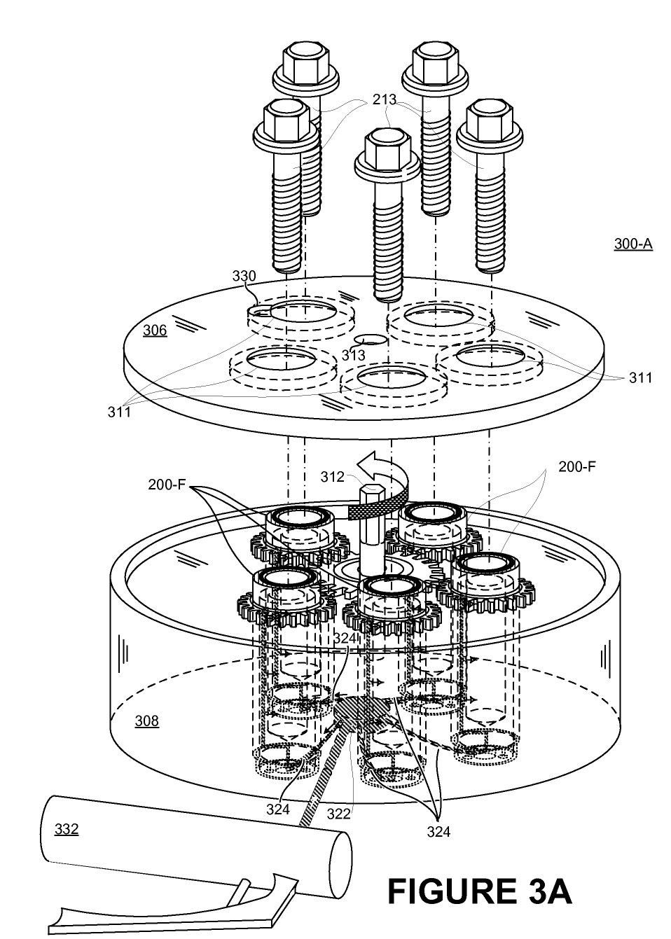

Referring now to FIGS. 2A, 2B and 2C an isometric view, top view, and cross-section view, respectively, of a lubricating device 200-A is shown, according to one or more embodiments. Lubricating device 200-A can be used to apply lubricant to threads on a stud that is affixed in a work piece, e.g., a stud embedded in a wheel hub for a car or truck. Lubricating device 200-A includes: a sleeve 210a having an inside, or chamber, diameter 216 that is larger than a fastener diameter to act as an enveloping housing around the fastener, e.g., bolt 213. Sleeve 210a has at least one conduit, e.g., 218 for function 106 of supplying lubricant into the chamber and onto the fastener; and a lubricant coupling 226a coupled to sleeve 210a for function 106 of supplying lubricant to conduit 218. In the present embodiment, the lubricant coupling 226a is a grease fitting, aka a zerk fitting, that can be rotatably coupled via a supply line to a manual or powered grease gun 332, the latter using electric or pneumatic force to pump the lubricant. The circular grease fitting 226a allows grease gun, e.g., 332 of FIG. 3A, to remain coupled to lubricating device 200-A and held stationary while grease fitting 226a and sleeve 210 rotate without leakage resistance. In another embodiment, lubricant supply line can be a hose or supply line that is rotatably coupled, e.g., via an o-ring sealed slip-joint to a lubricant reservoir in order to supply conduit 218 with lubricant. In the present embodiment, conduit 218 is a channel integrally located in sleeve 210a, e.g., from drilling holes at right angles to each other and inserting plugs, e.g., 234a and 234b, into any holes leading to the exterior of sleeve 210a. Alternatively, external tubing can be tapped into the sleeve to supply lubricant to the chamber. Sleeve 210a can be fabricated with integral conduits using a casting, e.g., investment casting, or a molding, e.g., in plastic or nylon parts. Lubricant can be any type of material desired for a given application including, but not limited to: oil, grease, anti-seize paste, liquid polytetrafluoroethylene (PTFE), water displacing penetrating oil spray, etc. in a wide variety of states such as liquid, paste, semisolid, aerosol, etc. Coupling 226a would be modified, as required, for the specific lubricant, e.g., an adapter can be used to fasten directly to, or indirectly attaché via a straw, to a hand-held can of aerosol lubricant. Vent holes in sleeve, positioned apart from the nozzle openings delivering lubricant to chamber, can aid in the flow and purging of air in the chamber, and thus aid in the delivery of the lubricant to the threads of the fastener. Using a screen or filter over exhaust holes will reduce exposure of toxic or messy lubricant to ambient surroundings.

Sleeve 210a has a closed bottom 228a in the bore, but can have an open bottom or a selectively open bottom, e.g., a threaded plug, to allow access to the entire bore for cleans out. A fastener to be lubed can be any type of part, including a fully or partially threaded device such as a screw, a bolt, a stud, etc., or any type of non-threaded part, e.g., a shank, shaft, etc. Furthermore, the present description can be used on an unattached fastener, e.g., loose, or on a fastener that is held in a work piece, e.g., a stud that is press fit into a wheel hub. Cavity in lubricating device 200-F has a depth 229 to accommodate a wide range of fastener lengths.

Chamber diameter 216 of sleeve 210 defines a chamber is sized sufficiently large enough to provide a clearance to the fastener diameter, e.g., diameter 215, in order to satisfy function 102 of FIG. 1 for preventing threads of a fastener from touching sleeve 210 that might otherwise interfere with applying a consistent layer of lubricant to the axial and circumferential location of threads. The clearance also allows the fastener to be inserted and removed from the sleeve with reasonable ease and to avoid damage to threads. Chamber diameter 216 is also sized small enough to provide a narrow gap between sleeve 210 and a fastener to create a viscous effect for semisolid or paste-type lubricants that draws the lubricant onto the fastener as a rotational motion is produced between the fastener and the sleeve. With a small enough chamber diameter 216, only a nominal amount of lubricant is required to coat threads of the fastener, thus reducing waste and mess that comes with excessive use of materials. Threads of a fastener may occasionally contact chamber diameter 216 during application of lubricant, yet that is not detrimental to the overall operation of the lubricating system. Chamber diameter 216 can be designed for a specific fastener diameter in order to provide optimal performance and minimum waste of lubricant. Alternatively, chamber diameter 216 can be designed to cover a reasonable range of fastener diameters. For example, for automotive and trucking applications, wheel bolts, or studs, come in standard sizes ranging over: 10 mm, 12 mm, 14 mm, 7/16 inch, ½ inch, 9/16 inch and ⅝ inch. Thus, a sleeve can be designed for individual fastener diameters, or for a reasonable size ranges, e.g., 12 mm & ½ inch, or for 14 mm and 5/16 inch. The present disclosure is well suited to any fastener size, providing the sleeve be sized appropriately.

In one embodiment, sleeve 210a is manufactured with an inside diameter equivalent to a nominal outside diameter of the target bolt size to be lubricated. For example, a ⅝ inch nominal bolt size has an outside thread major diameter (OD) of 0.625 inches will typically have an actual OD of 0.620 inches, e.g., because of rolled thread manufacturing and other factors. For that thread size, the sleeve 210-A would be manufactured to a inside diameter (ID) of approximately 0.625 inches in one embodiment to provide a nominal diametrical clearance of 0.005 inches, with one possible sleeve ID dimensional tolerance of 0.635+/−0.010 inch providing a diametric clearance range of 0.005 to 0.025 inches for a nominal fastener. The ID of the sleeve can be sized to provide clearance dimensions between the lubricating sleeve and the fastener having a wide range of values, e.g., from a minimum of approximately 0.004 inches to a maximum of over 0.050 inches, depending upon the type of lubricant delivered, the nominal sizes of the fastener, the type of lubricant, the statistical distribution of the actual tolerances of the population of fasteners, the temperature environment, etc. Thus, for example, a lubricating system designed for colder environments would provide more clearance for semisolid grease having a higher viscosity in the colder climate.

Sleeve 210a has been described in the previous embodiment as having a chamber diameter 216 only slightly larger than a diameter of a given target fastener. However, the present description is well suited to having a chamber diameter 216 that can fit a broader range of fastener dimensions. For example, chamber diameter 216 can be sized sufficiently large in one embodiment, e.g., 0.625 inches, to accommodate a reasonable range of fasteners in a given class, e.g., of wheel studs. Thus, wheel studs ranging from ⅝ inch to ½ inch could be grouped to use a single sleeve diameter of 0.625 inch, while wheel studs ranging from 10 mm to 7/16 inch can be grouped to use a different single size sleeve diameter of approximately 0.445 inch. While chamber diameter 216 might be sized ideally for the largest diameter fastener, e.g., ⅝ inch, it might not coat lubricant on a much smaller fastener, e.g., ½ inch, as efficiently. To accommodate this scenario, one embodiment includes a wiping blade, brush, or other protrusion aligned vertically, e.g., longitudinally along chamber axis, or positioned in a helical pattern for a screw effect along the bore of chamber diameter 216. The wiping blade would act as a dam for pooling lubricant pumped into sleeve 110, and force it onto threads of fastener as relative motion, e.g., turning, between fastener and sleeve is created by an operator, either manually or in a mechanized configuration.

Lubricating-sleeve 200 includes a pilot 214, which has a diameter smaller than inside diameter 216 of sleeve 210, e.g., 210a, b, or c, and larger than diameter of the fastener, e.g., 215, to satisfy function 104 of FIG. 1 of centering a fastener in sleeve 210 to ensure consistent application of lubricant on threads. Pilot 214 is located on the top face 212 as an integral part of sleeve 210 in the present embodiment. However, pilot 214 can alternatively be a separate part, e.g., a washer or bushing, made of any material, such as a low-friction nylon material. A bore in sleeve 210 is a blind hole with chamber diameter 216 that forms a conical shape 228a, or alternatively a square, bottom from the machining tool. The bore is deep enough for the longest fastener to be serviced by the lubricating device 200, e.g., the longest stud in a class of wheel studs. Bore can have various bottom configurations such as a longer taper towards the bottom to promote the centering of the end of a fastener inside sleeve 210.

Sleeve 210 also includes a scraper 230 coupled to, or formed in, sleeve 210 to satisfy function 110 of FIG. 1 for removing excess lubricant from the fastener when the fastener, e.g., bolt 215 and the sleeve 210 are disengaged. In the present embodiment, scraper 230 is implemented as an o-ring disposed in an o-ring channel 232 cut into sleeve 210. Alternatively, scraper can be an annular brush, felt pad, seal, or a very tightly tolerance internal diameter of the pilot itself. Scraper 230 can be a flexible washer, affixed to top face 212, with a hole diameter smaller than the fastener diameter, or with radial cuts therein that only flex to reveal the chamber diameter 216 of sleeve 210 and only when a fastener is pushed through the washer. Scraper function 110 provides for the removal of excessive lubricant from a fastener, ranging from scraper 230 touching the actual threads to scraper 230 having a clearance to the threads that allow varying thicknesses of lubricant to remain on the threads of the fastener.

While a single conduit, e.g. 218, is sufficient to lubricate fasteners in some applications, in different applications, sleeve 210 has a plurality of conduits disposed at different angular positions around sleeve 210. Similarly, while the present embodiment illustrates three nozzle openings 220a, 220b, and 220c, for dispensing lubricant onto the fastener, all arising from the single conduit 218, the present invention is well suited to implementing one or more nozzle openings, for each of the plurality of conduits described above, at the same or different heights, or axial locations, inside the sleeve 210. A primary nozzle opening location will be 220a located closer to the top of the chamber diameter 216, e.g., closer to top face 212a. This location provides lubricant to threads of both short and long bolts, whereas nozzle opening 220c located at the bottom of chamber diameter 216 would only be useful on fasteners with a long length that actually reached down in bore to location of 220c, but not on fasteners with a short length that would not reach nozzle opening 220c. In the latter case, grease would simply fill up the chamber. If only one nozzle opening is used, it is preferably located at nozzle opening 220a for the reasons described. However, the present invention can utilize a wide range of quantities of nozzle openings and a wide range of locations thereof, as dictated by specific applications of fastener shapes and needs. In another embodiment, a plurality of conduits can be arranged at different heights and at different evenly or irregularly spaced angular positions in bore of sleeve 210. Thus, one conduit can be located towards the top face 212 at angle 0° with a second conduit located mid-length of bore at 110° with a third conduit located towards conical bottom of bore and at an angle of 220°. In yet another embodiment, plurality of conduits can be located at the same height but at different angular locations around the circumference of sleeve 210, e.g., for dispensing of a more liquid-consistency lubricant more susceptible to gravity feed down length of vertically oriented fastener.

Referring now to FIGS. 2D and 2E, a top and cross-section view respectively of a lubricating device 200-D with an adapter is shown according to one or more embodiments. Sleeve 210 is essentially the same device from FIGS. 2B and 2C, but with an adapter 240a rotatably disposed around sleeve 210b to allow sleeve 210b to be rotated while a fastener is being lubricated. Pilot 214b with centering diameter is located in adapter 240a to provide centering function 104. Pilot 214b centering diameter is slightly smaller in one embodiment, than pilot 214a centering diameter for sleeve 210b because adapter 240a can remain stationary against a fastener and/or a work piece into which a fastener is affixed, during the lubrication operation, thus promoting a more accurate centering function.

Adapter 240a includes a retainer 236 for rotatably holding adapter 240a to sleeve 210. In the present embodiment retainer 236 is a thin flange/groove interface with rotatable motion. Alternatively, a retaining spring clip, or other means of rotatably coupling adapter 240a to sleeve 210 can be utilized. While adapter 240a extends to a length nearly equal to length of sleeve 210 in the present embodiment, in an alternative embodiment, adapter 240a can be a short cap, or a bushing or washer disposed on top face 212 of sleeve 210b with a centering diameter larger than that of a fastener but smaller than chamber diameter 216, in order to provide centering function 104. Alternatively sleeve 210 and adapter 240a can have o-ring grooves cut into their outer diameter and inner diameter, respectively, at the same axial location, e.g., at end nearest grease fitting 226, to accept a greased o-ring that would act as a retainer and allow rotational coupling.

Referring now to FIGS. 2F and 2G, a top and cross-section view respectively of a gear-driven lubricating device 200-F, is shown according to one or more embodiments. Gear-driven lubricating device 200-F is useful in a fastener lubricating system, shown in subsequent FIG. 3, where multiple instances of device 200-F are coupled to provide simultaneous lubricating operations on multiple fasteners via a single drive. Gear 250 is coupled to adapter 240b via a press fit, threads, or other mechanical attachment. Alternatively, gear 250 is integrally formed with adapter 240b, either as a molding, a casting, or as machined from a billet of any suitable material, such as aluminum, plastic, nylon, etc. Adapter 240b includes anti-slip o-ring 260a on top face that retains a fastener by the weight of the fastener, and the stiction property of the anti-slip o-ring 260a against the flange or head of the fastener. O-ring material can be rubber, fluourosilicon, or other material that provides grip in a slippery environment, e.g., an abrasive finish or impregnation. Pilot 214c in adapter 240b is formed from an inside diameter at the top of adapter. Sleeve 210c has threaded holes 228a to accept fasteners for retaining sleeve 210c in a stationary manner in housing while adapter 240b is rotated via gear 250, with fastener coupled thereto, in order to coat fastener with lubricant. Thus, in comparison to lubricating device 200-D where sleeve 210a rotates and adapter 240a can remain stationary, lubrication device 200-E allows adapter 240b to rotate while sleeve 210c remains stationary. In lieu of grease fitting for lubricant coupling 226b, the lubricating device 200-F can uses a tube coupled to sleeve 210b via a compression, flare or other type of leak-proof fitting. An alternative embodiment of FIG. 2G provides for lubricant conduit 218 to travel straight down to the bottom of the sleeve 210c and couple to fitting 226b which would be shifted off-center to vertically align with conduit 218, thereby avoiding the two 90 degree bends currently illustrated in conduit 218. In this embodiment, fasteners 213 would be relocated to either the center or other locations on the bottom 228a of sleeve 210c that would not interrupt with the conduit 218 or fitting 226b.

Referring now to FIGS. 2H, 2J, and 2K, close-up cross-section views of a top portion for different retention systems that hold a fastener in a lubricating device, is shown according to one or more embodiments. Lubricating device 200-H of FIG. 2H is an enlarged view of a top portion of device 200-F of FIG. 2G. Anti-slip o-ring 260a protrudes above top face 212 of adapter 240b to provide contact with an underside of the fastener head, or flange in order to retain fastener to adapter 240b when adapter 240b is rotated, e.g., via gear 250. Adapter has pilot 214b inside diameter though which a fastener will be inserted into sleeve 210c. Scraper o-ring 230 promotes the removal of excess lubricant when a fastener is extracted from sleeve 210c, thereby retaining excess lubricant within sleeve 210c. FIG. 2J is a lubricating device 200-J with one or more magnets 264 disposed in top face 212 of adapter 240b to retain a fastener having sufficient ferrous materials to be affected by a magnetic field. Magnets 264 can be retained by adhesive or mechanical retention in either a rigid or a floating manner. FIG. 2K is a lubricating device 200-K with one or more retaining clips 268 coupled to adapter 240b for mechanical retention of a fastener to lubricating device 200-K. Clips 268 are made of spring steel with sufficient curvature and spacing such that studs may be simply pushed down onto clips 268 and into bore of sleeve 210c.

Referring to FIG. 2L, a lubricating system 200-L having a sleeve insert is shown, according to one or more embodiments. Lubricating system 200-L includes an oversized sleeve 210d with an inside diameter 279a that is sufficiently large to lubricate a large diameter fastener, and sufficiently sized to accommodate a sleeve insert 272 to create the desired clearance between its inside diameter 280 and a fastener diameter to be lubricated, such that the functions described in FIG. 1 are satisfied. Depending upon the diameter of the fastener, a plurality of differently sized inside diameter sleeve inserts can be created to provide lubricating functions for a wide range of fastener diameters. Thus, a given sleeve insert can be designed for 7/16 inch, 12 mm and ½ inch diameter fasteners and another given sleeve can be designed for 14 mm and ⅝ inch diameter fasteners. Alternatively, different sleeve inserts can be made for each individual fastener diameter, depending on the accuracy desired, the type of lubricant used, and the application. A through hole 274 with a bevel, or countersink, is located at a height corresponding to height location of nozzle opening 220a and is also timed angularly to align with nozzle opening 220a in sleeve 210d. Locator pin 276a, press fit into sleeve insert 272 corresponds to a hole 276b in the bottom 228b of chamber, e.g., a flat bottom surface version of bore bottom 280 that ensures the alignment of hole 274 and nozzle opening 220a. The o-ring 231 in sleeve 210d now operates to center and retain sleeve insert 272 in lubricating device assembly 200-L, while o-ring 278 in sleeve insert 272 performs the function of a scraper or wiper to remove excess lubricant as a fastener is removed from lubricant device 200-L. Adapter 240d has an opening diameter 214d sufficiently large to accept the range of one or more sleeve inserts 272 for different fastener size. If different lengths of fasteners are to be lubed, then sleeve inserts with different lengths can also be used, with selectively created through-holes to match desired nozzle openings. For example, a sleeve 210d can have three or four nozzle openings, and then for short bolts, sleeve insert 272 only has a through hole at the top of sleeve insert 272, with no holes deeper in sleeve insert 272, thereby effectively only allowing lubrication into the inside diameter 280 of sleeve insert at the topmost nozzle hole location. This avoids pooling of lubricant at the bottom of the sleeve insert 272, for a short fastener with unblocked lower nozzle openings. Optional channel groove 275 is disposed over through hole to allow lubricant to communicate up or down the inside diameter 280 of sleeve insert 272 to a suitable length commensurate with the length of a desired fastener to be lubricated. Channel groove 275 assists in the dispersion of the lubrication along the entire length of the fastener.

Lubricating device 200-L can also include a height spacer 290 with height 292 of any value to match a given application where a shank on the fastener would not need lubrication within height spacer, but would need clearance to bottom of chamber, e.g., height 229. Height spacer 290 has o-ring 260b on its face that matches the function of o-ring 260a in prior embodiments. The outside diameter 214e of the lower portion of height spacer 290 fits into opening 214d of adapter 240d while inside diameter 279c is sufficient to allow sleeve insert 272 to slide in and out. In this manner, lubricating device 200-L is a modular system to allow accommodation of a wide range of fastener types, heights, diameters, shanks and threaded portions, etc. with minimal cost and equipment changes.

### Lubricating System

Referring now to FIG. 3A, an isometric view of a lubricating system 300-A with multiple lubricating-devices coupled to a single driver is shown according to one or more embodiments. System 300-A for lubricating fastener includes: a plurality of lubricating devices 200-F nested in a housing 308 with a cover 306 coupled to housing 308 by fasteners, a press fit, or some other mechanical retainer in order to contain the plurality of lubricating devices 200-F therein. Housing 308 effectively retains the plurality of adapters 240b and sleeves 210c that comprise each of the lubricating devices 200-F. System 300-A also includes a plurality of lubricant supply lines 324, each respectively coupled to a manifold 322 and to one of the plurality of sleeves 210c in order to supply lubricant to the inside diameter of each of the plurality of sleeves 210c for lubricating fasteners. Scallop cut 330 is an optional undercut in cover 306 to aid in removing fasteners from system 300-A, e.g., by slipping a finger or thumb under the flange or head of a fastener to pry it out of sleeve 210c then easily removed after the lubrication operation. Scallop cut 330 is helpful in an embodiment where fastener head protrudes beyond the OD of the adapter.

System 300-A also includes a driver 312 coupled to the plurality of sleeves, wherein driver 312 provides rotational force to spin each of the plurality of adapters 240b to be individually lubricated in each of the plurality of sleeves 210c. Driver 312 is a hex ⅜ inch drive in the present embodiment, coupled to gears 250 on each of the plurality of lubricating devices 200-F. Driver 312 can include a knurled knob or crank for manual operation of lubricating system 300-A. Alternatively, an electrically or pneumatically powered source can provide rotational motion to driver 312. In addition, any type of coupling arrangement besides gears can be used for the present disclosure. For example, plurality of lubricating devices 200-F can be coupled to driver 312 via a chain drive, a belt, or simply by direct contact, e.g., via rubber wheels in place of gears.

System 300-A also includes a lubricant pump 332 coupled to manifold 322 and then to the plurality of lubricant supply lines 324 in order to pump grease into the system. Lubricant pump 332 is a manual grease gun having a pumping lever, in the present embodiment. However, the present description is well suited to using a pneumatic or electrically powered source of lubricant from a reservoir directly into housing 308 via a grease fitting or a more permanent hose with pipe threads, compression or flare fitting, etc. Thus, in one embodiment, a portable cart contains lubricating system 300-A on a top shelf, with a lower shelf containing a lubricant reservoir, a pumping mechanism, and a power source, e.g., a battery, coupled together for mobile servicing of fasteners. In another embodiment, lubricant pump can be an aerosol can of water-displacing penetrating oil, or other lubricant, which is plumbed through lubricant supply line. Overspray and contamination is avoided by enveloping fastener in sleeve 210c, with sealing o-ring 260a preventing excessive escape. Optional exhaust hole(s) in housing 308 can allow for displacement of air in lubricant supply line and bore of sleeve and the entry of aerosol lubricant. A screen or filter on the exhaust hole can reduce escape of aerosol from the sleeve. Because the fastener is trapped in the sleeve, a significantly lower amount of aerosol lubricant is needed to lubricate the fastener. Additionally, overspray and toxic exposure to operators is reduced.

As described in FIG. 2G, each lubricating device 200-F has an individual adapter 240, for providing individual centering function, and an individual sleeve 210c respectively coupled thereto that, when taken together, provide a plurality of adapters and a plurality of sleeves 210c in lubricating system 300-A. Each of the plurality of sleeves 210c has an inside, or chamber, diameter 216 larger than a diameter of a fastener, e.g., fastener 213, and each of the plurality of sleeves has at least one conduit 220a, located therein for dispensing lubricant. While plurality of sleeves 210c have the same chamber diameter 216 in the present embodiment, the present description can utilize any combination of different chamber diameters 216 in plurality of sleeves 210c. Thus system 300-A could provide a universal lubricating system 300-A for a wide range of fasteners, such as having one sleeve ID sized for each of the different sized fasteners in an application, e.g., 10 mm, 12 mm, 14 mm, ½ inch 7/16, 9/16, and ⅝^{th} inch for wheel studs. Different sized lubricating devices 200-F can be removed from system 300-A and interchangeably replaced with desired sizes for a given application. In a case where less than all of the lubricating devices in the system are being used, the lubricant supply line can be valved to turn it on and off, or a dummy plug, with optional o-rings for sealing, can be inserted in the unused chambers to block the flow of lubricant, and thus avoid an unwanted accumulation of lubricant in the chamber.

While the present embodiment utilizes a round layout of five lubricating devices, the present disclosure is well suited to having any quantity and layout of lubricating devices in lubricating system, e.g., 2-6 or more, with six lubricating being an optimal quantity for vehicular applications with a matching quantity of studs per wheel. Furthermore, in another embodiment, driver 312 is internally disposed in housing 308 coupled with an electric motor to drive the plurality of lubricating devices 200-F, thus making insertion and removal of fasteners from lubricating system 300-A more convenient. A start button surface mounted on housing 308 may be used to activate a timed quantity of revolutions or time duration of turning plurality of sleeves 200-F, with automated pumping of lubricant from an electrical power source, such as a positive-displacement gear pump, thus automating the operation for time-savings, convenience, and error-proofing.

### Method for Lubricating

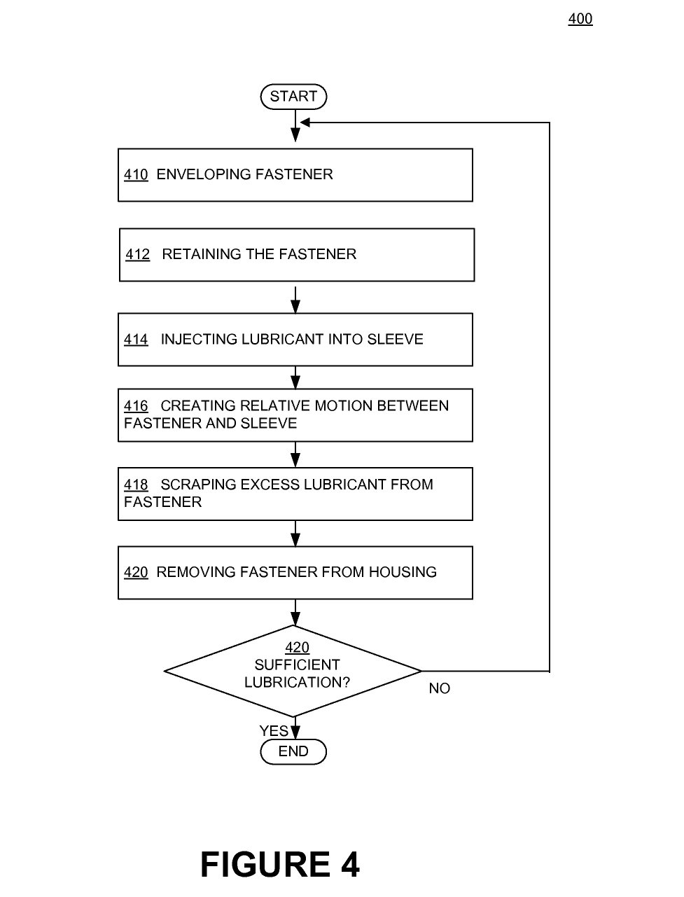

Referring now to FIG. 4, a flowchart 400 of a method for lubricating a fastener, according to one or more embodiments, starts with an operation 410 of enveloping the fastener in a sleeve having an inside diameter wherein the sleeve has at least one conduit with nozzle openings for dispensing lubricant onto the fastener. A fastener may be enveloped by placing a loose fastener into sleeve 210c of lubricating device 200-F of system 300-A or by placing lubricating device 200-A OR 200-D onto a fastener, such as an embedded stud, that is affixed to a work piece. By virtue of enveloping fastener in sleeve, a centering operation of the fastener within the sleeve occurs, e.g., via pilot 214a, whose diameter is larger than a fastener diameter, but smaller than sleeve chamber diameter 216. By centering fastener within sleeve 210a, the only physical contact to the threads is the lubricant where the viscous properties of lubricant are consistent around the full circumference of fastener, and thus, promotes consistent and thorough application of lubricant on fastener. Thus, threads of the fastener have no contact with lubricating equipment in the present embodiment. An exception would be the use of a brush or wiping blade to assist with the application of lubricant to the threads.

Optional operation 412 is for retaining a fastener to the lubricating device in order to ensure relative motion between the fastener and the sleeve, and thereby ensure thorough coating of lubricant on threads of fastener. Any apparatus that retains fastener to sleeve 210c may be used, e.g., slip-resistant rubber of FIG. 2H, magnetic retention of FIG. 2J, or mechanical retainment of FIG. 2K.

Operation 414 of injecting a lubricant via a lubricant supply line, attached to the sleeve via a coupling, then into the inside diameter of the sleeve via a conduit and nozzle openings is performed by activating a manual or powered grease gun 332 or reservoir. Only a nominal quantity of lubricant is used in the present operation, due to the efficiency of the device and system described in the present disclosure. Typically, one to three pumps of a manual grease gun 332 is sufficient for a typical automotive wheel stud. For an embedded stud, after injecting of lubricant into lubricating device 200-A or 200-D, the grease gun 332 may remained coupled to, or removed from, lubricating device 200-A or 200-D, whichever is more convenient. For loose studs placed in lubricating system 300-A lubricant supply can be permanently coupled thereto, as loose studs are easily inserted and removed from the system.

In order to coat the full circumference of threads of fastener with lubricant, when lubricant is only injected at one or more point locations of sleeve 210a, 210b, or 210c that are arranged vertically and/or circumferentially at same or different height locations, operation 416 of creating a relative motion between the fastener and the sleeve is performed. Relative motion is a rotational movement, such as the counterclockwise arrow shown in FIGS. 2A-2K and 3, though a clockwise direction may be used as well. In another embodiment, placement of conduits in sleeve, e.g., 210c, with a brush or wiper configuration may dictate a preferred unidirectional movement of lubricating device, e.g., 200-F. Modified rotations can be performed for additional confirmation of complete lubricant coverage, e.g., one complete revolution counterclockwise, followed by one complete revolution clockwise. Operation 416 of creating relative motion may be accomplished by manually rotating sleeve 210a or 210b of FIGS. 2C or 2E, respectively, a desired amount of rotation about a fastener affixed to a work piece, or by placing one or more loose fasteners into a lubricating device 200-F of lubricating system 300-A of FIG. 3 and driving a single driver manually or with a power source to rotate adapter portion 240b the desired amount of rotation to lubricate the plurality of fasteners simultaneously.

The present disclosure is well suited to a wide variety of rotational algorithms depending upon circumstances of an application, properties of any one of a wide range of lubricants, and other factors. For example, if a thicker lubricant is used, e.g., one having anti-seize additives for a harsher environment, or in a colder environment where viscosity increases, then more than one revolution may be required to ensure thorough coating of all threads. For another application in a less severe environment, use of water-displacing penetrating oil aerosol may only require a one-second to five-second burst of spray with zero rotation up to pi-radian, or one-hundred and eighty degrees, or more amount of rotation to lubricate the full circumference of the threads of the fastener. The amount of rotation depends upon the configuration, location and quantity of lubricating conduit(s) 218 and nozzle openings 220a, b, and c. The higher the quantity of conduits and nozzle openings spaced angularly around a sleeve, the proportionally less amount of rotation between the sleeve and fastener is needed. Thus, for example, two equispaced conduit/nozzle opening arrangements would only require a pi-radian, or one-hundred and eighty degrees rotation compared to a single conduit/nozzle opening arrangement. Similarly, three equispaced conduit/nozzle opening arrangements would only require a ⅔ pi-radian, or one-hundred and twenty degrees rotation compared to a single conduit/nozzle opening arrangement. A new, or freshly cleaned, lubricating system 300-A, may require seasoning of sleeves 210c with a couple to several rotations, e.g., 720 to 1080 degrees, or more and repeated application of lubricant such that all internal parts are coated with lubricant in anticipation of accepting a first batch of fasteners to be lubricated. Thereafter, a smaller amount of rotation, such as 180 or 360 degrees might be sufficient, depending upon the application. Procedures can be developed for given applications indicating amount of rotation and quantity and spacing of applying lubricant without manual inspection and touch up to search for dry spots, thereby reducing time and ensuring consistent and thorough application of lubricant to threads, e.g., for consistent run-down torques and resultant preload and resistance to corrosion and seizing during field operation.

The combination of one or more operations that envelope, center, inject lubricant on, and rotate a fastener contribute to creating a viscose effect on the lubricant, between the fastener and the sleeve in order to draw the lubricant onto the threads of the fastener. In the case of an aerosol lubricant, the same combination of one or more operations contributes to a thorough and low-mess coating of fastener threads with lubricant.

In operation 418, a Scraping excess lubricant from the fastener occurs upon operation 420 of removing fastener from the sleeve, e.g., by use of scraping o-ring 230, located in sleeve 210a, 210b, or 210c, depending on lubricating device configuration. Fasteners can be removed from lubricating system 300-A manually, e.g., by using fingers to grab the head of the fastener and lift it out, with the benefit of the head being free of grease using the present system. Alternative device features or parts can ease the operation of removal of fasteners. For example, optional scallop cut 230 in cover 306 allows space for a user's finger to fit under the head of the bolt and more easily remove it. An optional ring (not shown) with a handle and spring clips can be used to retain to all five fasteners in lubricating system 300-A allowing clipping in and removal of all five fasteners simultaneously. Alternatively, a socket with one or more rubber protrusions from the flats, or a magnetized portion thereof, will allow temporary retention of fasteners sufficient to remove the fasteners from lubricating system 300-A.

Lubricating device and system efficiently use lubricant to coat fastener threads. As such, minimal waste or accumulation occurs. Regardless, an optional operation for both lubricating device and system provides periodically cleaning by disassembly of parts and immersion in solvent with optional ultrasound agitation to remove any accumulated lubricant and contaminant.

While the invention has been described in detail herein in accordance with certain preferred embodiments thereof, many modifications and changes therein may be effected by those skilled in the art. For example, while the present disclosure focuses on the automated and enclosed lubrication of externally threaded fasteners, the invention is equally well suited to a device for lubricating of internally threaded devices. In that embodiment, a male insert with a lubricant coupling, conduit and nozzle openings to its outside diameter that is dimensioned appropriately to the female threaded part to be lubed, would provide the appropriate lubrication using a methodology of providing a metered amount of lubricant and turning the male lubricating device to distribute the lubricant around the axial and circumferential extent of the threads. For example, methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained. Accordingly, the specification and drawings are to be regarded in an illustrative rather than a restrictive. It is intended by the appended claims to cover all such modifications and changes as fall within the true spirit and scope of the invention.

I/we claim:

1. A device for lubricating a fastener comprising:
a sleeve having a blind hole with an inside diameter to receive the fastener; and
means for dispensing lubricant into the blind hole for lubricating the fastener.

2. The device of claim 1 wherein the sleeve has at least one conduit located therein with at least one nozzle opening to the inside diameter of the sleeve for dispensing lubricant therein.

3. The device of claim 1 wherein the sleeve has a pilot for centering the sleeve about the fastener, wherein the pilot has an inside diameter that is smaller than the inside diameter of the sleeve, and wherein the inside diameter of the pilot and the inside diameter of the sleeve are both greater than an outside diameter of the fastener to be lubricated.

4. The device of claim 1 wherein the sleeve further comprises a scraper coupled to the sleeve in order to remove excess lubricant from the fastener when the fastener is removed from the sleeve.

5. The device of claim 1 further comprising:
a plurality of conduits and a plurality of nozzle openings disposed in the sleeve at different heights or different angular displacements along inside diameter of sleeve for dispensing lubricant onto the fastener at a plurality of locations.

6. The device of claim 1 further comprising:
a coupling that is coupled to the sleeve and is rotatably coupleable to an external source of lubricant to accept lubricant for application onto fastener while sleeve is rotated about the fastener.

7. The device of claim 1 further comprising:
an adapter, rotatably disposed around the sleeve wherein the adapter allows the sleeve to be rotated while the fastener is being lubricated.

8. The device of claim 1 wherein the inside diameter of the pilot maintains a clearance between the inside diameter of the sleeve and the outside diameter of the fastener to be lubricated in order to allow the lubricant to coat the entire circumference of the fastener.

9. The device of claim 1 wherein a narrow clearance between the sleeve and the fastener to be lubricated creates a viscous effect to draw the lubricant onto the fastener as the sleeve or the fastener is rotated to apply the lubricant to the length and circumference of the fastener.

10. The device of claim 1 wherein the inside diameter of the sleeve is approximately 0.003 to 0.030 of an inch larger than a nominal size of a fastener to be lubricated.

11. The device of claim 1 further comprising:
a sleeve insert having an outside diameter to fit inside sleeve, and an inside diameter designed for a given fastener diameter to be lubricated, wherein sleeve insert is selectively interchangeable with other sleeve inserts having a different inside diameter for a different fastener diameter to be lubricated.

12. The device of claim 1 further comprising:
a height spacer that removably couples to an adapter in order to accommodate a fastener having a height that is greater than the depth of the sleeve.

13. A system for lubricating fasteners comprising:
a plurality of sleeves each having a blind hole with an inside diameter larger than a diameter of a fastener to be lubricated, means for dispensing lubricant into the blind hole of each of the sleeves for lubricating the fasteners;
a housing for retaining the plurality of sleeves; and
a plurality of lubricant supply lines, each of which are individually coupled to one of the sleeves in order to supply lubricant to the inside diameter of each of the sleeves for providing lubricant to fasteners.

14. The system of claim 13 wherein each of the sleeves has at least one conduit and at least one nozzle opening located therein for dispensing lubricant into the blind hole for lubricating the fasteners

15. The system of claim 13 further comprising:
a lubricant pump coupled to the plurality of lubricant supply lines in order to pump grease into the system.

16. The system of claim 13 further comprising:
a plurality of adapters, each of which are individually coupled to one of the sleeves, to provide centering capability for each of the plurality of fasteners.

17. The system of claim 13 further comprising:
a driver coupled to the plurality of sleeves, the driver providing simultaneous rotational motion each of the plurality of fasteners to be lubricated in their respective sleeves.

18. The system of claim 13 wherein the plurality of sleeves can lubricate a plurality of fasteners simultaneously.

19. A method of lubricating a fastener comprising:
disposing the fastener in a sleeve having an inside diameter wherein the sleeve has at least one conduit for dispensing lubricant onto the fastener;
injecting a lubricant via a lubricant supply line, coupled to the sleeve, into the inside diameter of the sleeve;
creating a relative motion between the fastener and the sleeve in order to coat threads of the fastener with lubricant.

20. The method of claim 19 wherein the operations of enveloping, injecting, and creating a relative motion are performed simultaneously on a plurality of fasteners.

21. The method of claim 19 further comprising:
driving a single driver to lubricate the plurality of fasteners simultaneously.

22. A device for lubricating a fastener comprising:
means for providing relative motion between the fastener and a housing that applies lubricant to the fastener than a diameter of the fastener, wherein the sleeve has at least one conduit located therein for dispensing lubricant onto threads of the fastener; and
means for supplying a lubricant to the housing for application to the fastener.

23. The device of claim 22 further comprising:
means for dispensing lubricant simultaneously to multiple points on the fastener.
